(19) United States
(12) Patent Application Publication
(10) Pub. No.: US 2005/0091136 A1
(43) Pub. Date: Apr. 28, 2005

(54) Asset recovery network

(75) Inventors: Walter E. Buczynski, Brentwood, CA (US); B.J. Hawkins, Marina Del Rey, CA (US)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(73) Assignee: OFFICE FUTURE SYSTEMS, A California Corporation

(21) Appl. No.: 10/928,614

(22) Filed: Aug. 27, 2004

Related U.S. Application Data
(60) Provisional application No. 60/499,092, filed on Aug. 29, 2003.

(51) Int. Cl. G06F 17/60

(52) U.S. Cl. 705/35

(57) ABSTRACT

Electronic asset disposal request forms are created, approved, and forwarded to a surplus property disposal professional who then may modify and supplement the electronic request forms to create electronic postings that are accessible over a computer network to interested potential buyers. The potential buyer may then create an offer which is processed electronically. The surplus property professional may have discretion to determine which potential buyers are eligible to participate and whether to invoke an automated “last and final” bidding process, as well as the ability to select between a simple “for sale” posting and a “closed bid” posting. Details of pending auctions may be automatically circulated to participants in prior auctions of similar items and to other registered buyers who have expressed interest in those types of items. The result is a flexible mechanism that is fair and efficient for all concerned.

### CROSS REFERENCE TO RELATED APPLICATIONS

This application claims priority from U.S. Provisional Patent Application Ser. No. 60/499,092, filed Aug. 29, 2003, which is hereby incorporated by reference.

### TECHNICAL FIELD

The invention relates to computerized systems and methods for advertising and selling materials and equipment over a computer network such as the internet. More particularly, the system provides a large organization with a flexible mechanism for the disposal of surplus assets in a manner that is fair and efficient for all concerned.

### BACKGROUND

A “closed bid box” process is used by many business organizations and government entities to award competitive contracts and to dispose of surplus assets. In such a typical such process, details of the competition are published and bidders submit sealed bids prior to a set deadline. BiddingNET is an example of a closed bid box process which makes extensive use of computerization and computer network technology to provide a computerized closed bid box on an internet web site which is accessible to registered sellers, under the control of a professional buyer. In accordance with the conventional rules applicable to any “closed bid box” auction, all bids are strictly confidential until they are opened at the end of the auction; however, in some cases the professional buyer will actively monitor when bids are received and from whom, and may be given the right to terminate or extend the deadline or to restart the process on modified terms and conditions if he is not satisfied that sufficient qualified bidders are competing to produce a competitive price. The professional buyer may also be given the authority to reject any bid that is not responsive, or from a bidder with doubtful qualifications, or that is otherwise not in the best interest of the buyer's organization. BiddingNET is the subject of commonly assigned U.S. Patent Publication US 2002/0107775 A1 dated Aug. 8, 2002, which is hereby incorporated in its entirety by reference.

Another type of competitive bidding process is an “open auction” system in which the current price is announced to all prospective bidders as the auction proceeds, Depending on the applicable rules, the auction is terminated at a fixed time (which encourages all bidders to wait until the last moment) or at the whim of the auctioneer (who can thus encourage an unsuccessful bidder to make an even higher bid). In either case, a bidder can bid through a proxy to maintain his anonymity or to hide his maximum price. Alternatively, in a so-called “Dutch” auction, the price is incrementally dropped until a bid is received (which encourages bidders to offer their maximum price). eBay is a well known example of a computerized auction process that includes a number of variations on a traditional open auction.

Surplus materials and unused assets present special issues to business organizations and government entities. On the one hand, disposal of such assets is outside the normal organizational responsibilities and expertise and it is difficult to determine a fair resale price from readily available information such as depreciated cost or replacement cost. Moreover, disposal of surplus of unascertainable value presents opportunity for fraud and legal challenges, as well as possibility for product liabilities, warranty claims, and taxes. Accordingly, it is often simpler and safer to destroy the unwanted inventory and dispose of it for scrap value, or to incur on-going storage and maintenance expenses for assets that have no operational value to the organization, or to simply give it away to a related company or to a local charity.

RequisitionNET is a computerized tool for maintaining efficient communication between an operational entity and a professional buyer assigned to that entity, at the same time facilitating and enforcing best practices in the procurement process such as appropriate review and approval of all requisitions, ensuring that all qualified bidders (and only qualified bidders) are permitted to participate, and verifying that any subsequent changes in the requisition are appropriate to the needs of the requesting organization. RequisitionNET is the subject of commonly assigned U.S. Patent Publication US 2002/0107713 A1 dated Aug. 8, 2002, which is hereby incorporated in its entirety by reference.

### SUMMARY

In one embodiment of a computerized asset recovery system particularly suitable for a large organization with many operational units, each operational unit has responsibility for identifying surplus material and assets assigned to that unit that are no longer required for the unit's operational responsibilities. Electronic asset disposal request forms are created, approved, and forwarded to a surplus property disposal professional. The professional then may modify and supplement the electronic request forms to create electronic postings that are accessible to interested potential buyers. Each such electronic posting will typically include a description of the property and the applicable terms and conditions. The potential buyer may then modify and supplement the posted information to create an electronic offer and submit that offer electronically to the surplus property professional in accordance with the posted terms and conditions. The system then presents the submitted electronic offers to the surplus property professional for electronic acceptance or rejection in accordance with the previously posted terms and conditions.

In particular, the surplus property professional may be given at least limited flexibility to determine which potential buyers will have the right to review and respond to a particular posting, and to select the rules that establish when and to whom the responsive electronic offers will be accessible. For example, the professional may decide to limit the potential buyers to other organizational units of the same company or to reject all offers that are below a certain reserve price. Alternatively, the system may be programmed to require that prior to offering the surplus property to unrelated entities, the property must first be offered for redeployment within the company on a cost only, fixed price or best price basis.

As a further enhancement, the system may provide the disposal professional with an automated “last and final” bidding process in which the highest bidder faces a second round of competitive bidding from his closest rivals after the results of the initial round have been posted.

Preferably, the surplus property disposal professional can select between at least two entirely different auction schemes depending for example on the uniqueness of the property, its potential value, and how many potential bidders can be expected to submit substantial bids: a simple “for sale” posting in which all offers are accessible to all participants and the property professional may accept any offer at any time, and a “closed bid” in which the amount of each bid is not known to the disposal professional or other participants until the bidding period has ended. In particular, such an automated “for sale” process allows for the fast turn around of assets, those that have less value, or may not be sold normally because of the usual paperwork processing costs. Offers are collected as they are submitted and the sale is consummated when the seller determines an adequate price is reached in the bidding. On the other hand, the “closed bid” process provides a private competitive bid process that is more complex to administer, but is nevertheless particularly suitable for more valuable assets in which it is critical that the final price is established by competitive market forces and that no bidder will be seen as having any unfair advantage over any other r bidder.

Because all communications and transactions are processed by networked computers, details of pending auctions may be automatically circulated to participants in prior auctions of similar items and to other registered buyers who have expressed interest in those items. Furthermore, the system can easily maintain a complete database of all buyers and their corresponding interest areas and a complete history of all transactions (including dates, parties, prices and terms and conditions), for use in auditing and financial reporting as well as in the management and defense of potential liability issues regarding the item(s) sold.

The invention is defined in the appended claims, some of which may be directed to some or all of the broader aspects of the invention set forth above, while other claims may be directed to specific novel and advantageous features and combinations of features that will be apparent from the Detailed Description that follows.

### FIGURES

Certain characteristics, features and advantages of various preferred embodiments are depicted in the accompanying drawings, in which:

FIG. 1 is a flowchart of an exemplary Internal Request Process

FIG. 2 is a screenshot of an exemplary Request Retrieval

FIG. 3 is a screenshot of an exemplary Request Detail

FIG. 4 is a flowchart of an exemplary Auction Process incorporating various novel aspects of the present invention.

FIG. 5 is a flowchart of an exemplary Bidding Process

FIG. 6 is a screenshot of an exemplary Request Selection by the ARP

FIG. 7 is a screenshot of an exemplary Open Bid Retrieval by the ARP

FIG. 8 is a screenshot of an exemplary Sell Retrieval by the ARP

FIG. 9 is a screenshot of an exemplary Bid Edit by the ARP

FIG. 10 is a screenshot of an exemplary Bid and Sell Selection by the Buyer

FIG. 11 is a screenshot of an exemplary Bid Detail as presented to the Buyer

FIG. 12 is a screenshot of an exemplary Bid Line Item Retrieval by the Buyer

FIG. 13 is a screenshot of an exemplary Bid Line Item Draft Response by the Buyer

FIG. 14 is a screenshot of an exemplary Bid Header Response Draft by the Buyer

FIG. 15 is a screenshot of an exemplary Submitted Bids Retrieval by the Buyer

FIG. 16 is a screenshot of an exemplary Submitted Sells Retrieval by the Buyer

### DETAILED DESCRIPTION

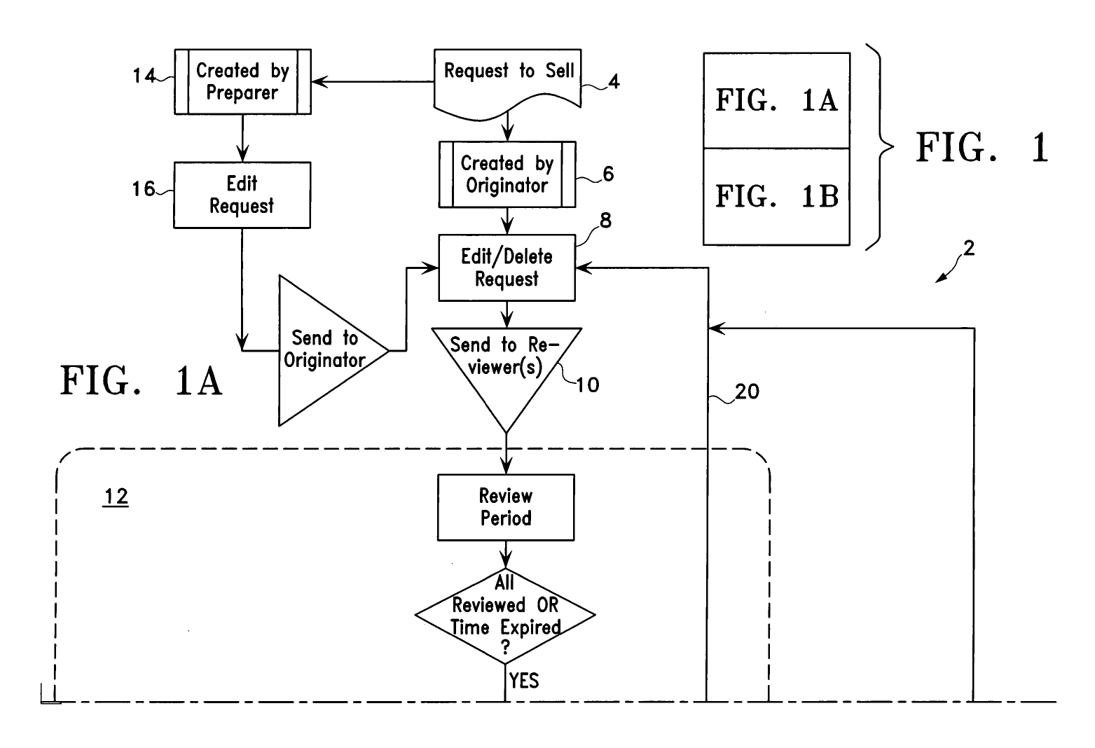

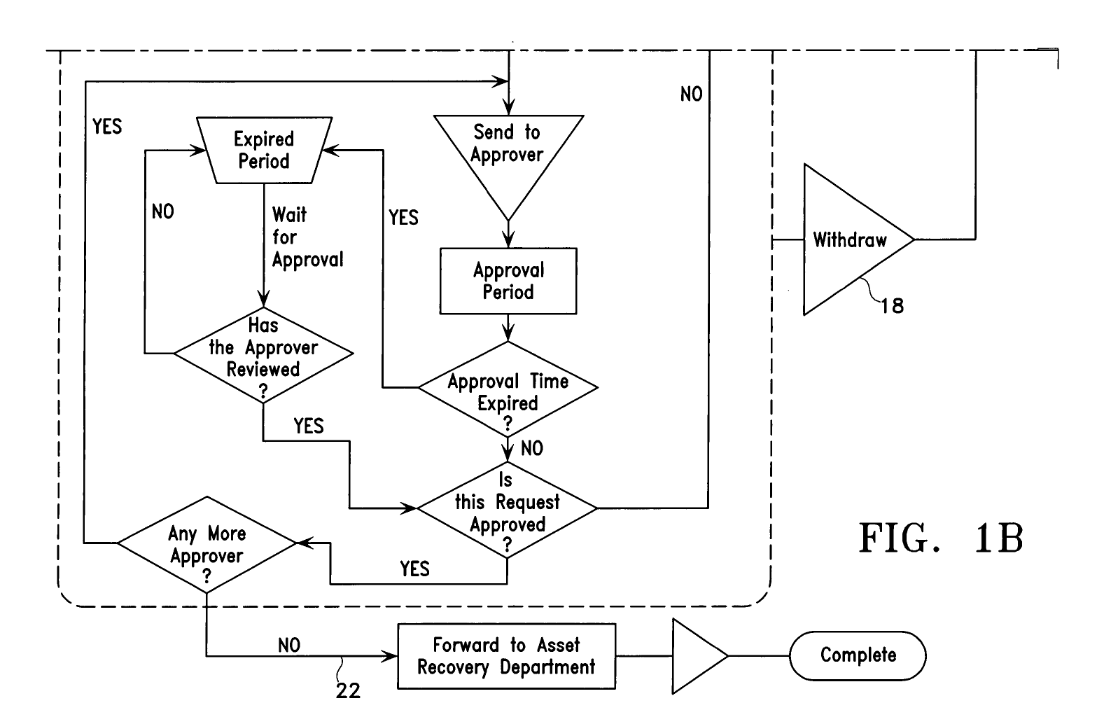

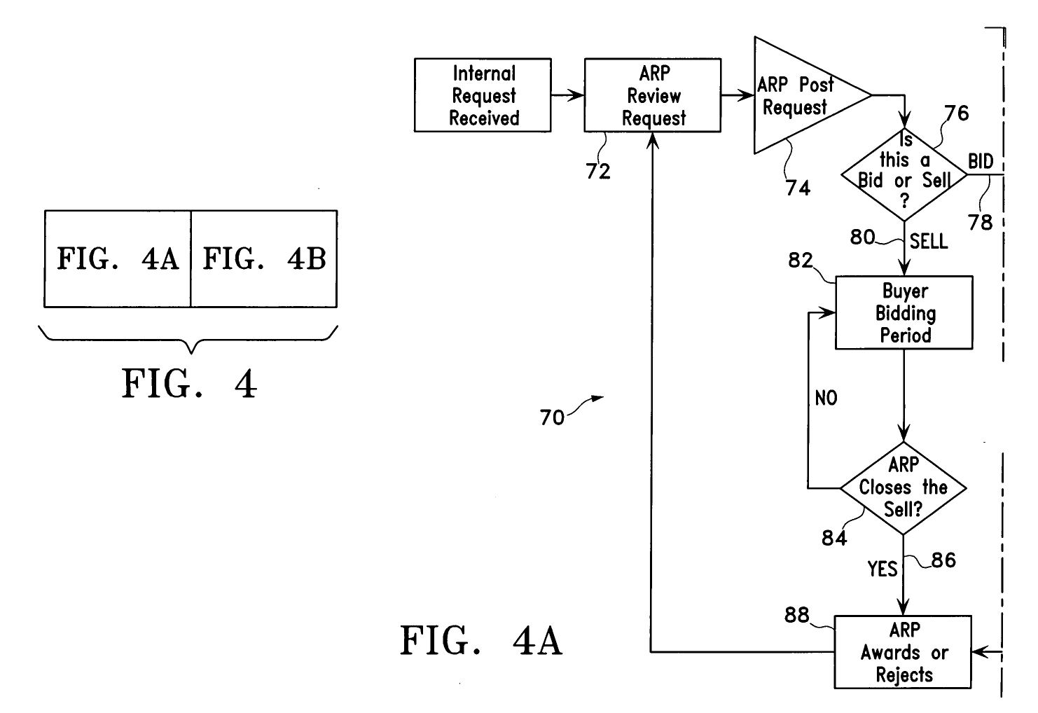

Referring now to FIG. 1 which is a flowchart of an exemplary Internal Request Process 2, it may be seen that a Request 4 to sell surplus property may be created (block 6) and edited/deleted (block 8) by an Originator prior to submission (block 10) to a comprehensive review and approval process (block 12) as described in more detail in the referenced RequisitionNET Patent Publication. Optionally, the preliminary creation (block 14) and editing (block 16) of the Request may be performed by a Preparer prior to any revision (block 8) by the originator, with that Preparer always having the final say as to whether the Request is to be submitted or Deleted. In particular, the Originator may Withdraw (block 18) the request even after it has been submitted for review and approval, and is automatically given an opportunity to edit or delete any Request that is not Approved (NO branch 20). Assuming that all involved Approvers have approved the Request (NO branch 22), and that it has not been Withdrawn by the Originator, the approved Request is then automatically forwarded (block 24) to a responsible Surplus Asset Recovery/Disposal Professional (hereinafter “ARP”) in the Asset Recovery Department, as will hereinafter be described in more detail with respect to FIG. 4.

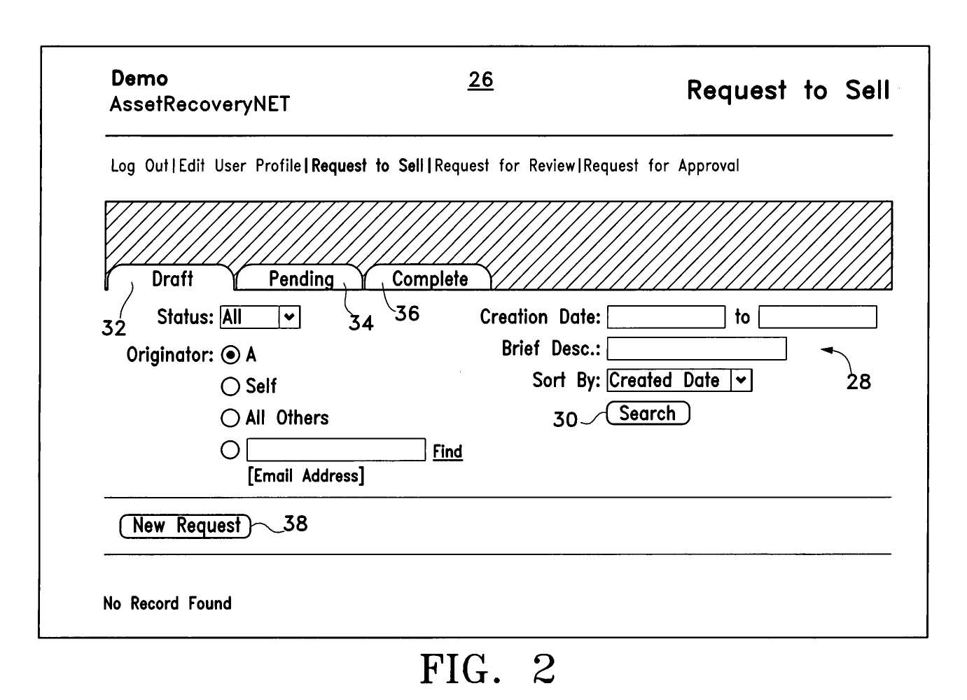

Reference should now be made to FIG. 2 which is a screenshot showing the opening screen 26 used by the Preparer or Originator to retrieve (Search criteria 28 and Search button 30) previously created Draft (tab 32), Pending (tab 34) and Completed (tab 36) requests, as well as to commence preparation of a New Request (button 38). A simplified version of screen 26 may also be provided to Reviewers (link 40) and Approvers (link 42) for selection of various categories of Requests for which they are responsible.

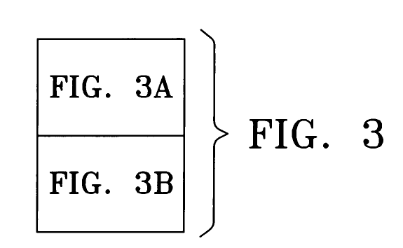

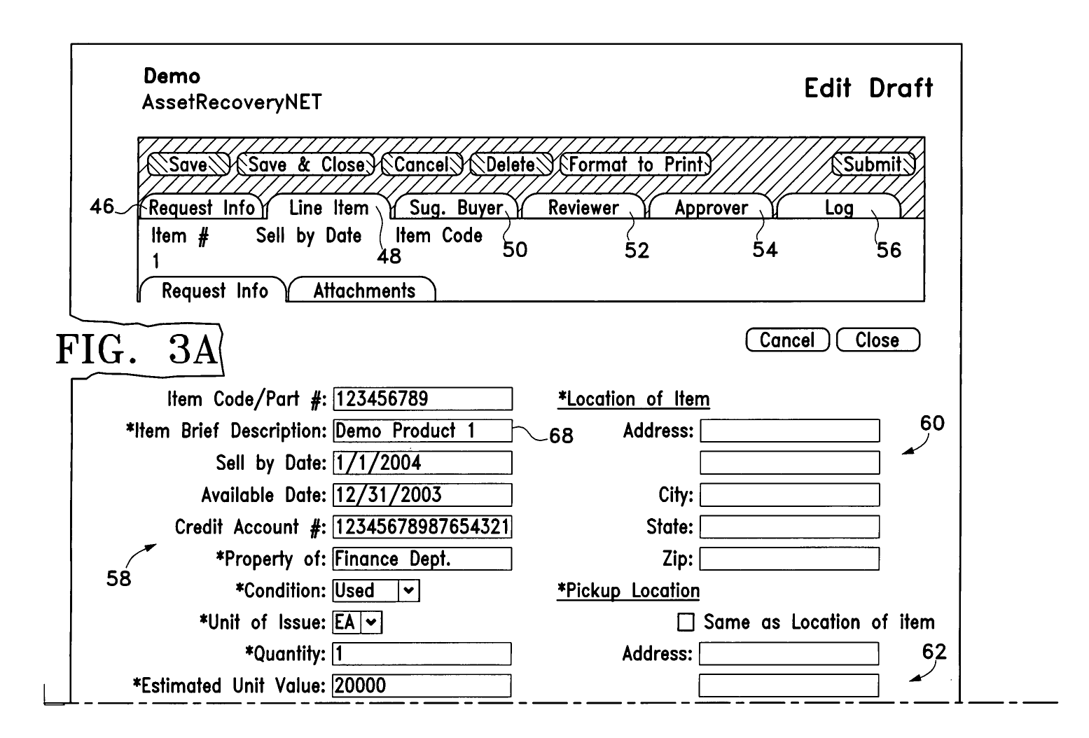

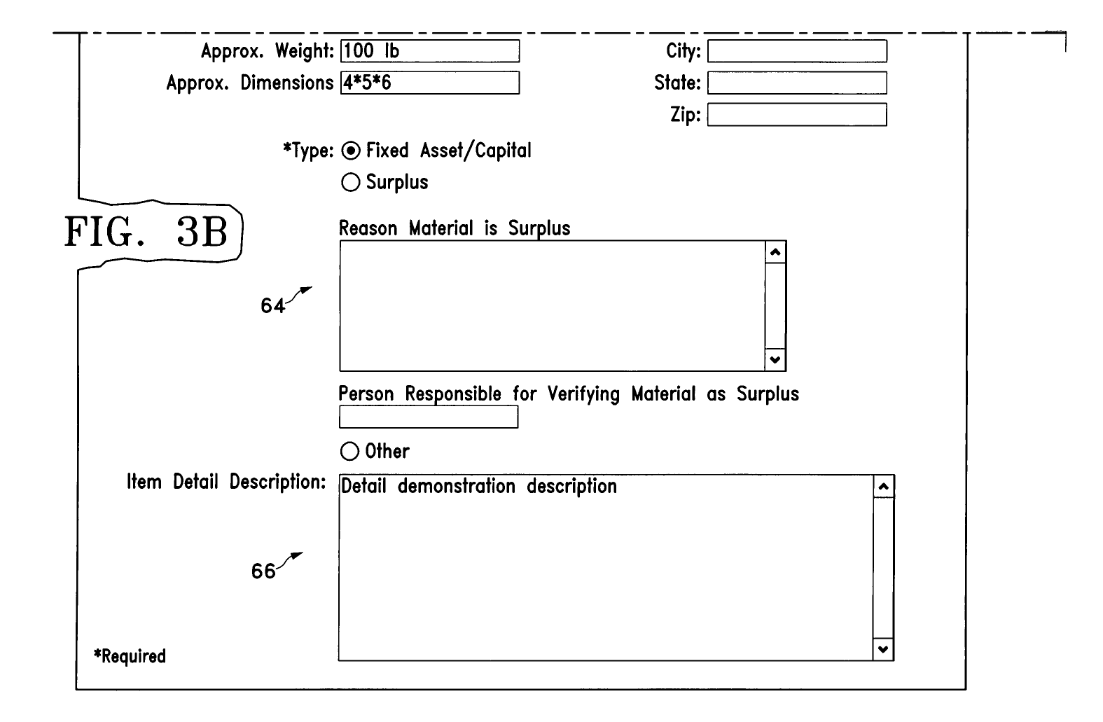

FIG. 3 shows an exemplary Edit screen 44 with tabs of viewing and editing the Draft information concerning the basic Request (tab 46), the individual line items (tab 48), any prospective Buyers known to the Originator (tab 50), a list of proposed Reviewers (tab 52), a list of required Approvers (tab 54), and a Log (tab 56) which documents any changes to Request 46.

In particular, the Request 46 is preferably divided into Line Items each with their own identification, description and ownership details 58, as well as details concerning the Location 60 at which the item is currently located (for possible inspection) and the Location 62 at which it may be picked up. Details 64 are preferably also provided about the accounting status of the item in question and to provide a more detailed description 66 of the item in question than the simple Brief Description 68 used for line item identification purposes. By so dividing the Request 46 into a number of Line Items 48 or lots, not only are the individual items more precisely identified and accounted for, it will be possible for Buyers to bid only on those items 48 in which they are particularly interested and for the ARP to selectively accept Bids for some but not all of the Line Items 48 listed on a particular Request 46.

Once the Request has been completed, reviewed and approved, it is forwarded to the Asset Recovery Department for processing in accordance with the flowchart of FIG. 4.

In particular, the Surplus Asset Disposal process 70 commences with processing 72 of the Request 46 by the ARP, with an eye to the Posting 74 of the processed Request on a networked website. In accordance with whether the Posting (decision block 76) is to solicit formal Bids (BID branch 78) or is a more informal Fast Sell.

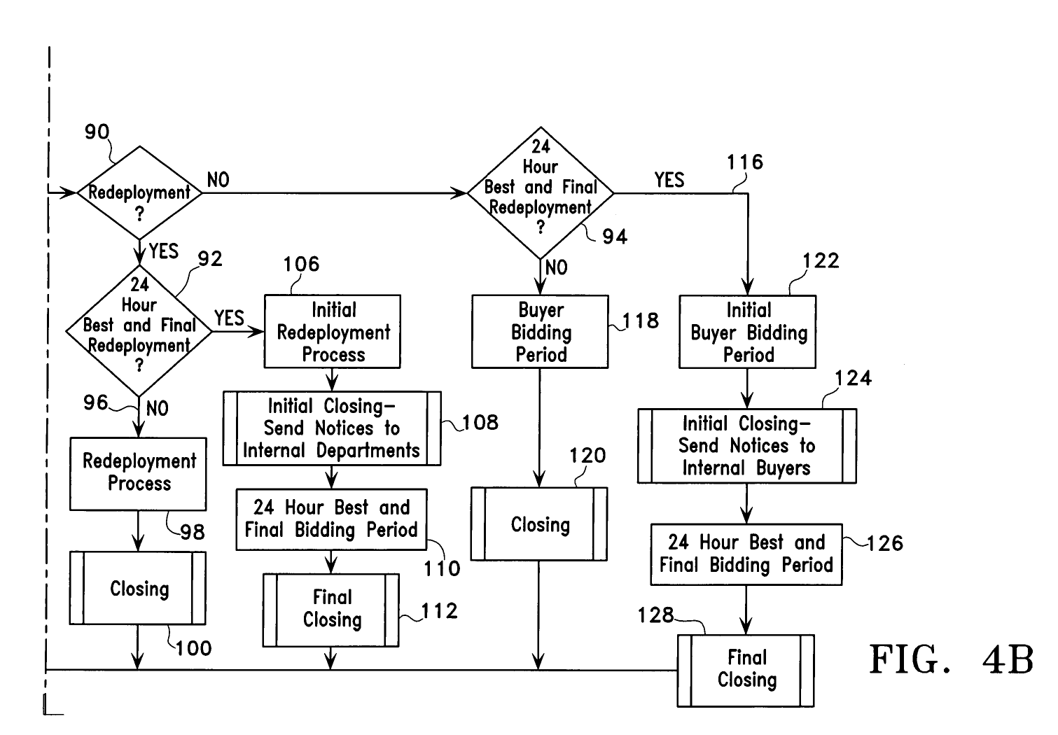

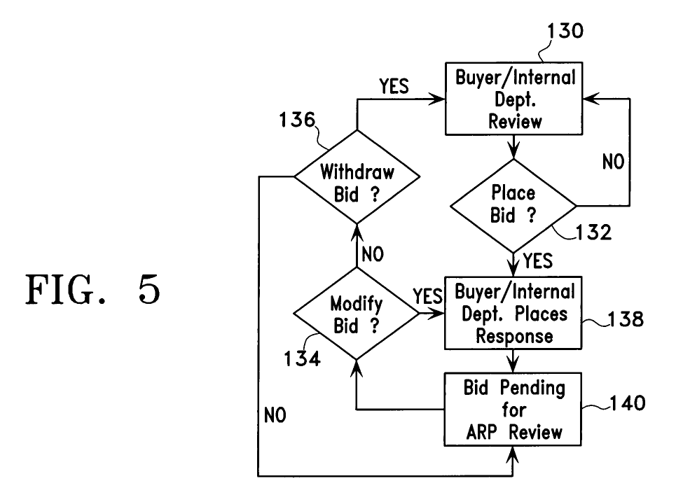

In the event the Posting is an open Fast Sell posting (SELL branch 80), the posting remains in effect for Buyer Bidding Period (block 82) (described in more detail herein with respect to FIG. 5). The received bids are reviewed from time to time by the ARP and (block 84) once an acceptable Bid has been received or if the ARP determines that there is not sufficient interest in the Item to justify keeping the Posting active (YES branch 86), the Bidding Period is Closed by the ARP and the highest Bid is reviewed by the ARP to determine if it should be Awarded or Rejected (block 88).

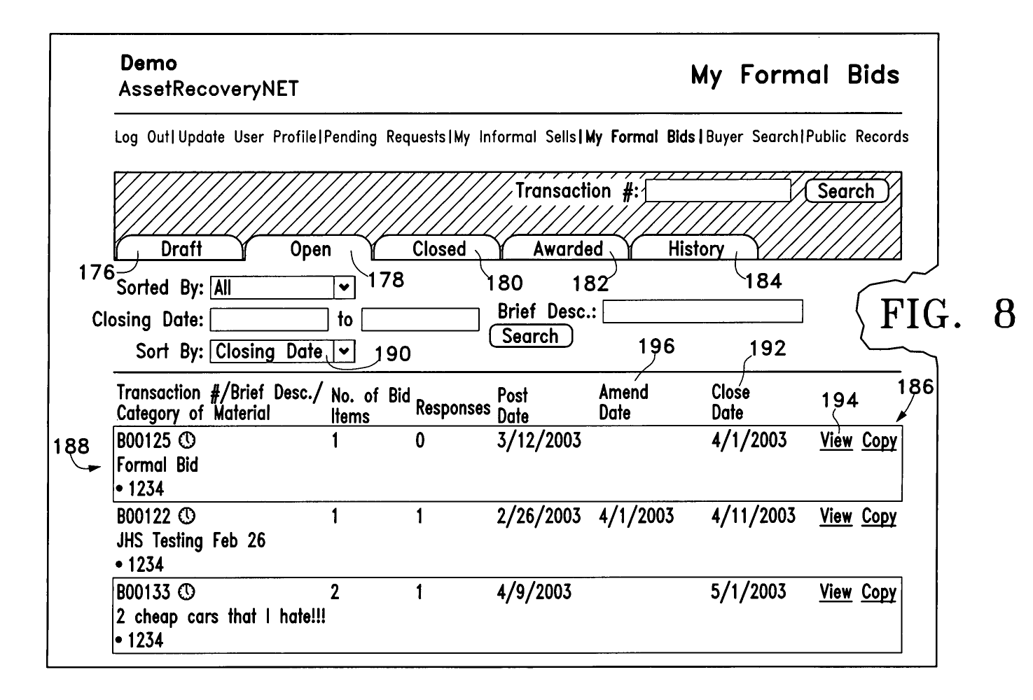

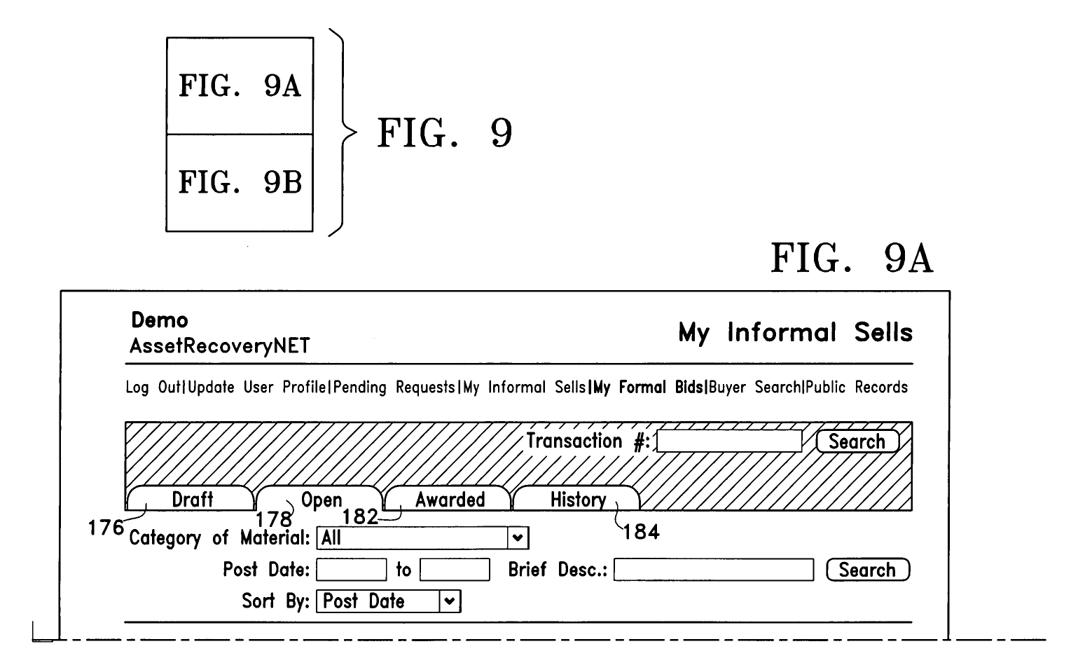

If the Posting is for a closed bid box (sealed bid) posting (BID branch 78) then a second test is made to determine whether the ARP has specified a Redeployment Posting (test 90) and/or a 24 Hour Best and Final Bid (tests 92, 94). If the Posting is for a simple Redeployment (NO branch 96 from test 92) then a simple Redeployment process (shown in more detail in FIG. 5 and FIG. 9) is initiated (block 98) which is automatically closed (block 100) at the predetermined time and the results passed on to the ARP for Award or other appropriate processing (previously described block 88). In particular, if no Internal Departments have submitted acceptable bids, the ARP will have an opportunity to review and edit the Request (block 72) for subsequent Posting as simple Fast Sell or a formal solicitation from bidders outside the organization (NO branch 102).

Alternatively, if the Posting is for a 24 Hour Best and Final Redeployment (YES branch 104 from test 92), then an Initial Redeployment Process 106 (similar to process 98) followed by an initial Closing (block 108) which differs only from the previously described closing 100 in that a limited number of high bids are selected and their respective bidders are provided with an additional 24 hours to revise their bids for a subsequent round of bidding (block 110) followed by a Final Closing (block 112) that is essentially the same as the previously described Closing of block 100.

Assuming that the Posting is not for a Fast Sell (SELL branch 80) or an internal Redeployment (YES branch from Redeployment test 90), then it is a formal closed bid box solicitation directed to all registered bidders, and at the option of the ARP may be either a Regular Bid process (NO branch 114 from test 94) or a 24 Hour Best and Final Bid process (YES branch 116). No branch 114 leads to a Buyer Bidding Period 118 that is similar to the previously described Redeployment Process 100 except that it is open to all registered bidders, followed by a Closing 120 that is the same as the previously described Redeployment Final Closing 112. In particular, the ARP will Accept or Reject the bid from the highest bidder (block 88), and if that highest bid is rejected, may repost the request, possibly in edited form.

YES branch 116 reflects a Posting for a formal closed bid process (122, 124) that is open to all registered bidders and that is followed by a Best and Final process 126 128.

Reference should now be made to FIG. 5 which is a more detailed description of the Bidding process of blocks 82, 98, 106 and 122. In particular, while the bidding process is active, the prospective Buyer (or in the case of a Redeployment, the interested Internal Department) has access to the Posting (block 130) and may Place 132 a new Bid or Modify 134 or Withdraw 136 an existing Bid. Whenever a new or modified bid is placed 138 the ARP is notified 140; however, in the case of a closed or sealed bid process neither the ARP nor any other bidder is notified of the amount of the bid until the bidding process is closed.

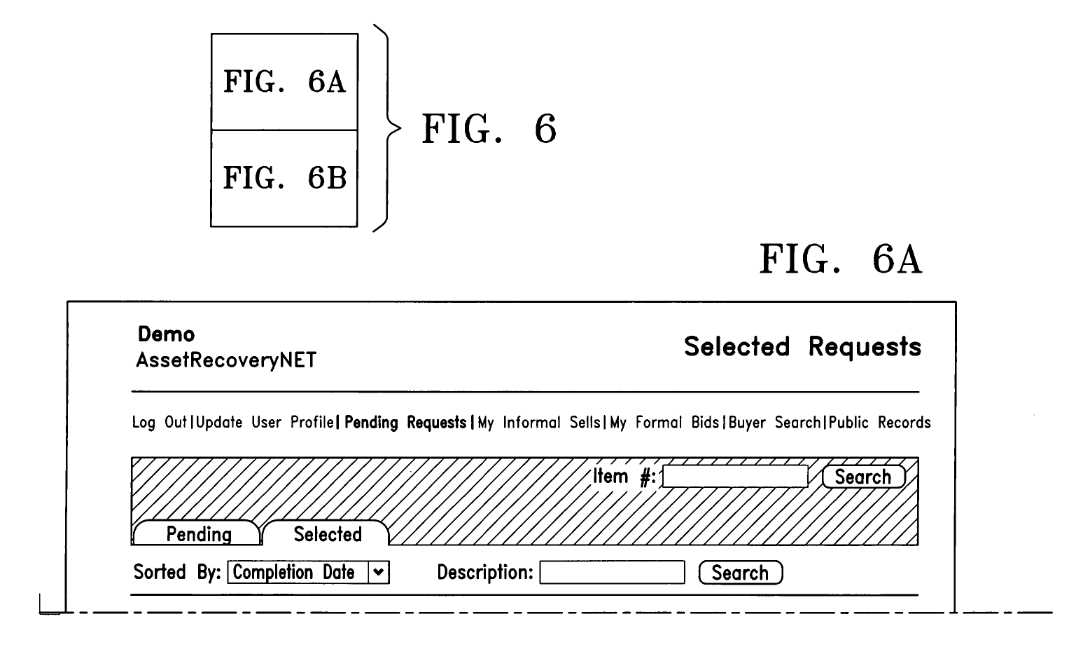

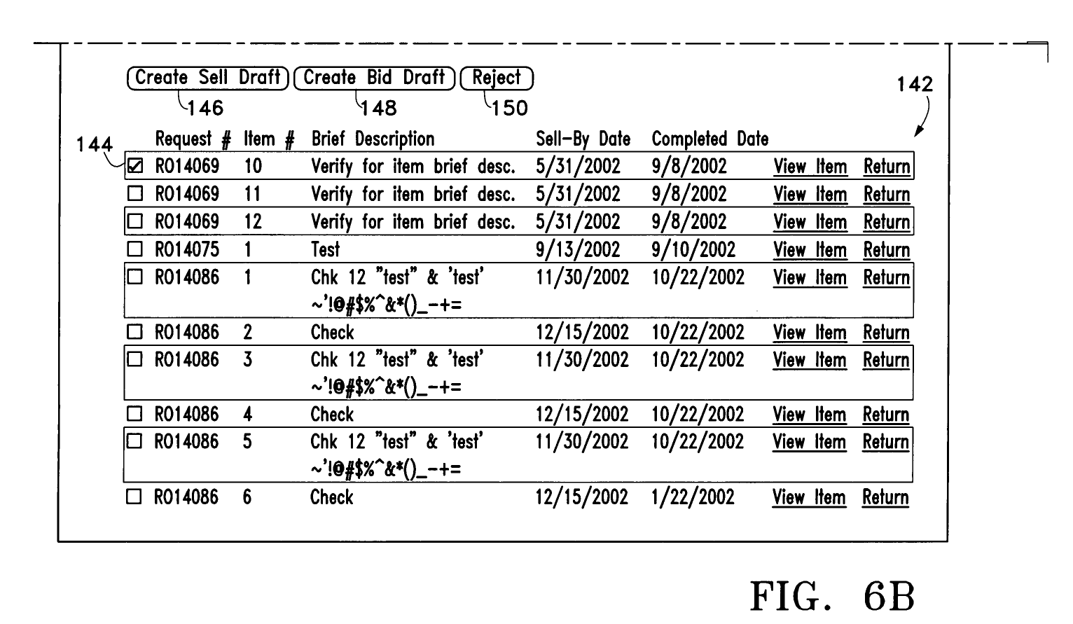

FIG. 6 depicts the screen used by the ARP to review (block 72 of FIG. 4) and list line items 142 from multiple Pending asset disposal Requests, and to select one or more of the listed items for Posting (block 78). In particular, the ARP can check particular line items (check box 144) and combine the checked items into either a Sell Draft (tab 146) for processing in accordance with SELL branch 80 of FIG. 4) or a Bid Draft (tab 148) for processing in accordance with BID branch 78. Alternatively, the ARP may also select Pending disposal Requests for Rejection (tab 150), if in his professional opinion they are not suitable for even the informal Fast Sell process.

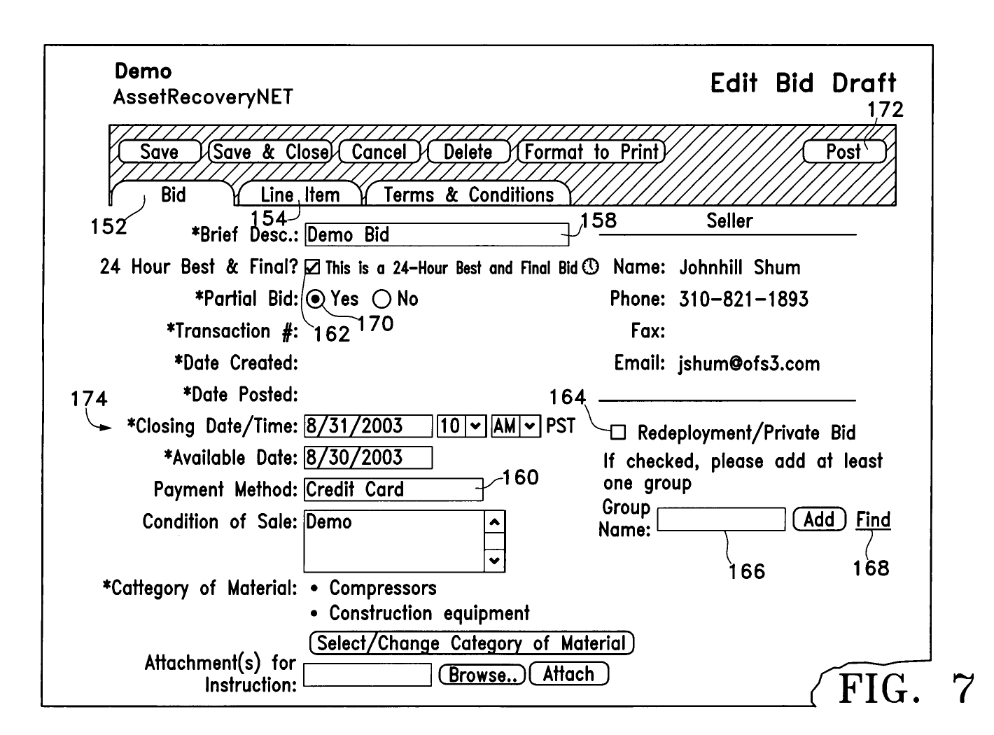

FIG. 7 depicts the screen used by the ARP to Edit a Bid Draft once it has been created. Note that the screen has three tabs: the active Bid tab 152, a Line Item tab 154 (which causes the Line Items associated with that Bid Draft to be displayed for viewing and editing) and a Terms & Conditions tab 156 which provides the ARP with an opportunity to view and possibly modify all the associated legal fine print. Some of the displayed fields, such as Brief Description field 158, are initially populated with values from the original Request, for possible editing by the ARP, while other fields such as Payment Method 160 are input by the ARP (possibly using previously specified default values). Two fields ARP originated fields are particularly noteworthy “24 Hour Best & Final” checkbox 162 (which signifies that the items in question are sufficiently unique and valuable to justify a second round of bidding) and Redeployment/Private Bid checkbox 164 (which gives priority to a defined Internal Department or other related entity, possibly on terms more favorable than would be extended to outside bidders). Note that if the ARP does check the Redeployment/Private Bid checkbox 164, it is also necessary to identify the Group 166 that is eligible to bid, possibly using Find link 168.

Once the ARP has Edited the Request, including details of each included Line Item and whether a prospective Buyer may bid on only a partial lot (radio button 170), the ARP uses the Post button 172 to commence the formal bidding process. A similar process with analogous screens is also provided for Fast Sell Postings, but without a fixed Closing Time 174 and without any possibility of Best & Final 162 or Redeployment 164 options.

FIG. 8 shows the screen used by the ARP to keep track of the various Formal Bids for which the ARP is responsible, including those still in Draft 176, Open 178, Closed 180 and Awarded 182, as well as a tab for a History 184 of fully completed transactions As depicted, the Open tab 178 is active, and the display shows a columnar listing 186 of various Open Postings 188, sorted by a user specified sort key 190 (in the depicted example, in ascending order of closing date 192).

Each Posting row 188 includes a link 194 to a more detailed screen for Viewing and possible action by the ARP. In the event that the ARP elects to Amend a Posting while the Bidding Period is still open or after the period has Closed but no bid has been Awarded, the Amend Date 196 is noted in the listing for that Posting 186. By monitoring this listing, the ARP is thus able to identify any potentially troublesome Open bids that may require additional attention, such as personally contacting potential buyers, or Amending and/or re-Posting the Bid to attract more interest.

FIG. 9 is similar to FIG. 8 but shows the screen used by the ARP to keep track of the ARP's Informal Sells. Note that there is no Closed Tab 180 various Formal Bids. Moreover, the listing includes the current High Bid 198, there is no closing date 192, and to keep the process simple, each item is separately listed.

FIG. 10 through FIG. 16 depict various aspects of the activities performed by the Buyer (or Internal Department in the case of an Internal Redeployment) during the Bidding/Redeployment Processes of FIG. 4 and FIG. 5.

FIG. 10 depicts the Selection screen used by an authorized Buyer to review and possibly Respond to the Bids and Sells posted by the ARP. The screen is currently opened at Selected tab 200. Other tabs accessible to this Buyer are Open tab 202 which includes all currently active Bid Postings accessible to this Buyer and Draft tab 204 which includes all Bid Postings for which this Buyer is in the process of preparing a responsive Bid. Note that the Buyer has various fields in which to enter selection criteria to limit the number of Posted transaction appearing in listing 206, including predetermined Categories 208 and Types 210, as well as keywords 212 from the Brief Description, and date ranges for Closing 214 and Posting 216.

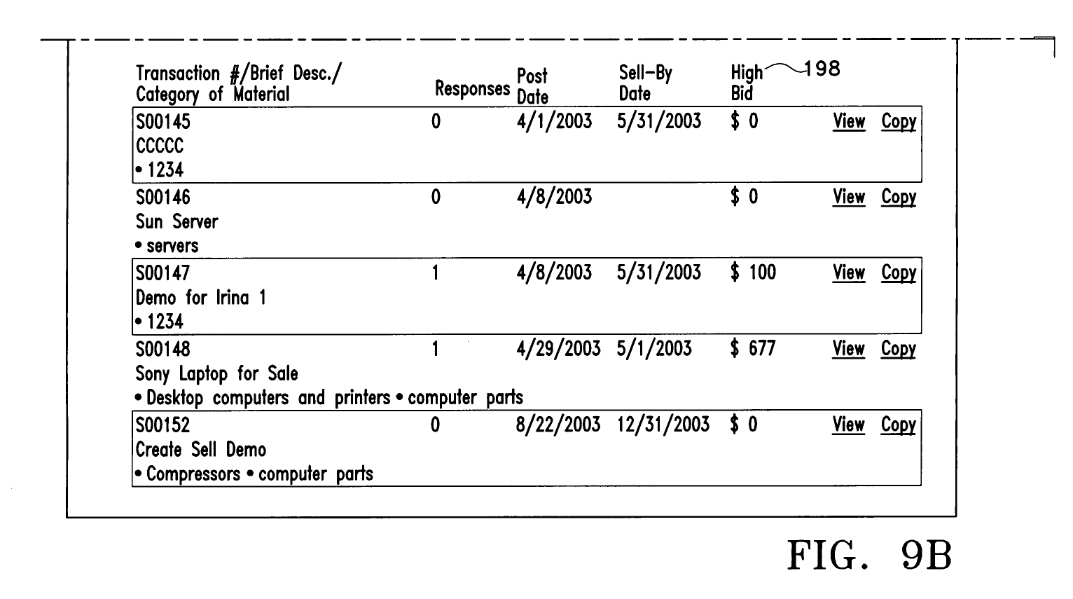

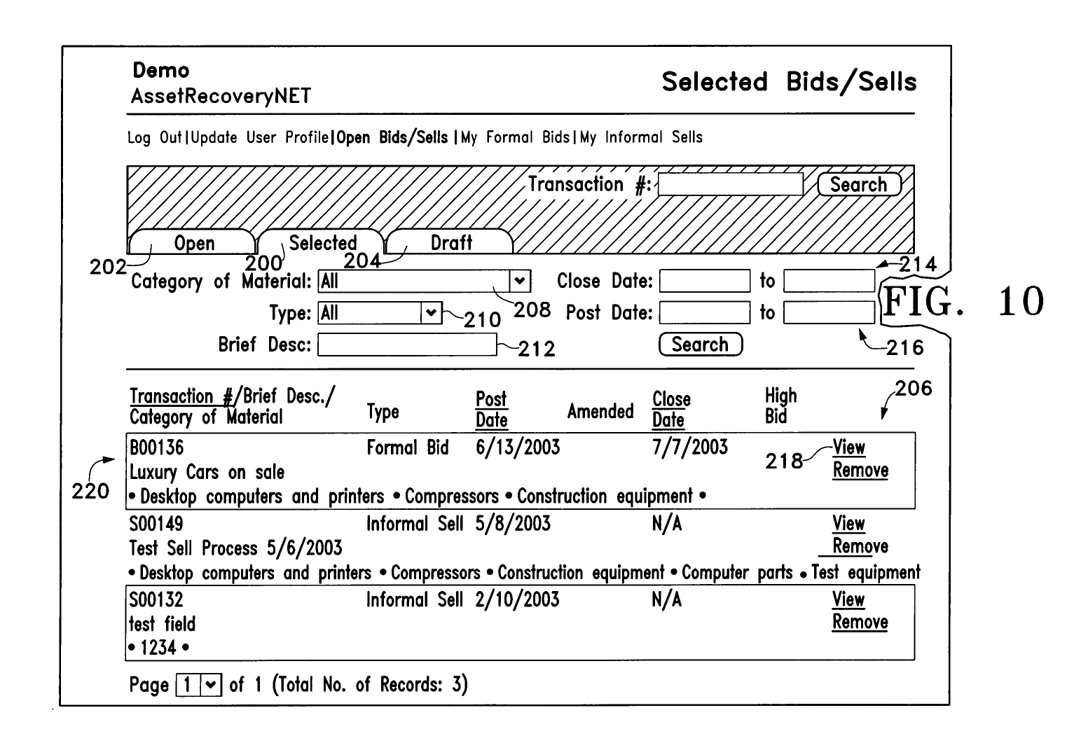

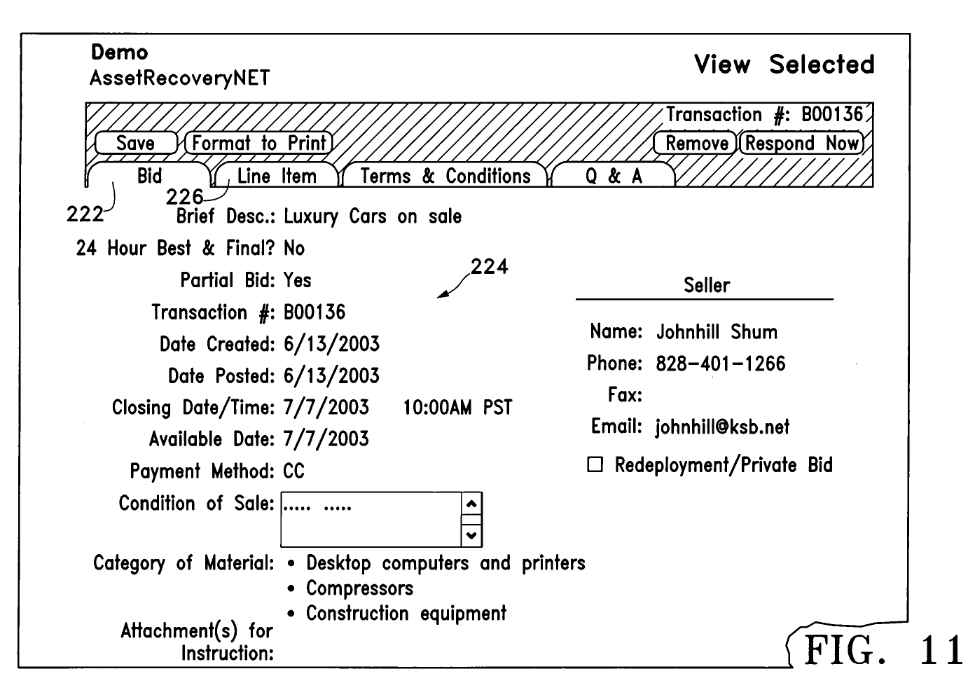

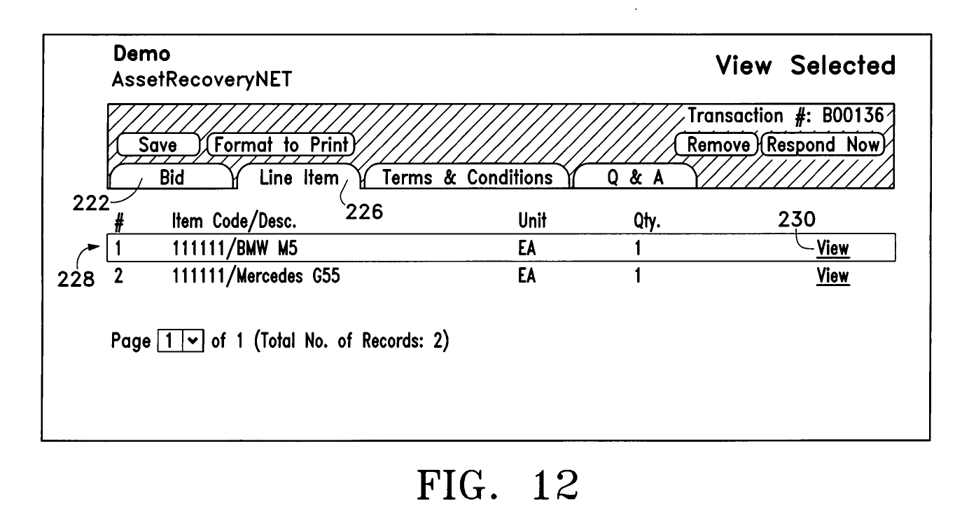

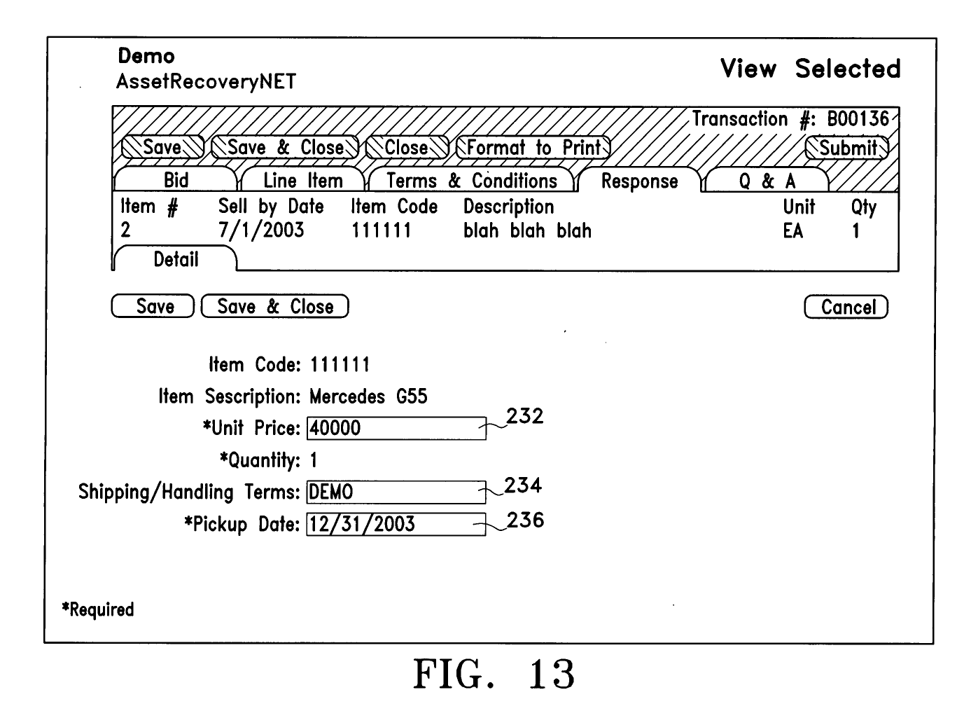

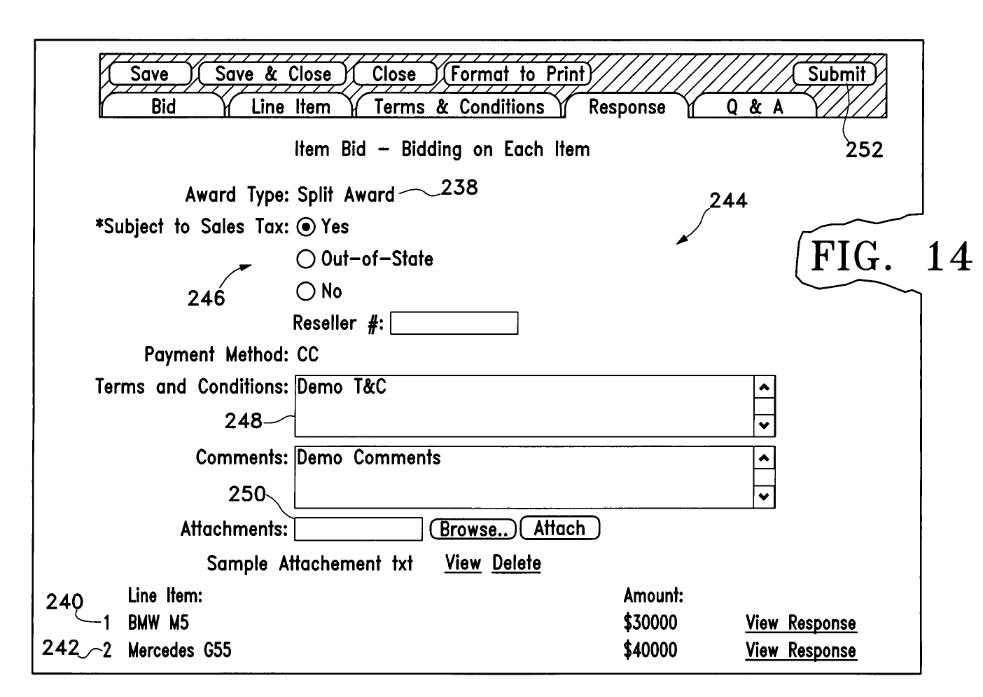

FIG. 11 shows the View screen that appears when the Buyer clicks on the View link 218 of FIG. 10 associated with a particular Posting 220. The Bid tab 222 displays the Header information 224 for the posting, while as shown in FIG. 12, the Line Item tab 226 displays a Header for each Line Item 228. By clicking on the View link 230 for a particular Line Item 228, the Buyer opens a detailed Response screen (FIG. 13) in which the Buyer may enter a Price 232, Shipping Terms 234, and Pickup Date 236, prior to saving the Line Item Response information and returning to the draft Bid Response Header screen of FIG. 14. In particular, when a particular Bid Posting is for more than one Line Item and the possibility of a Split Award has been authorized by the ARP (Award Type 238), the Buyer fills out a separate Detailed Response (FIG. 13) for each Line Item of interest 240, 242 and a covering Transaction Header Response 244 common to all, which include Buyer specific information such as Tax status 246, special Terms and Conditions 248, and Buyer generated Attachments 250 such as his standard Purchase Order terms. Once the entire Response form has been completed to the Buyer's satisfaction it is submitted to the system (button 252) and relevant details are automatically distributed to the ARP and to the other Buyers as appropriate.

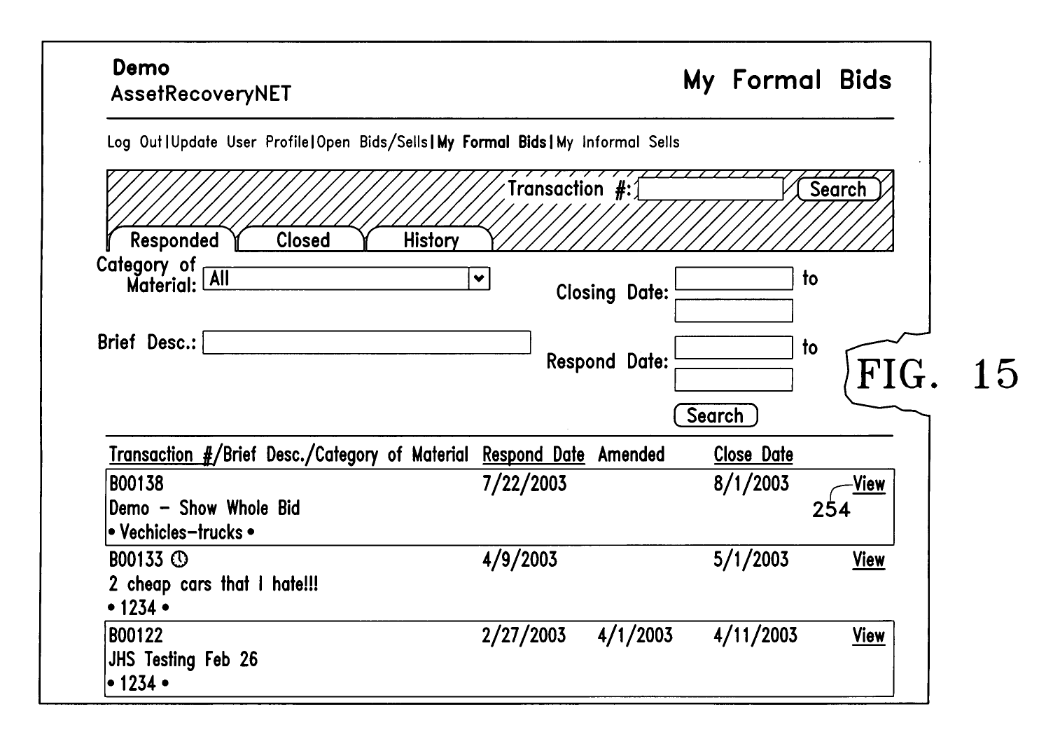

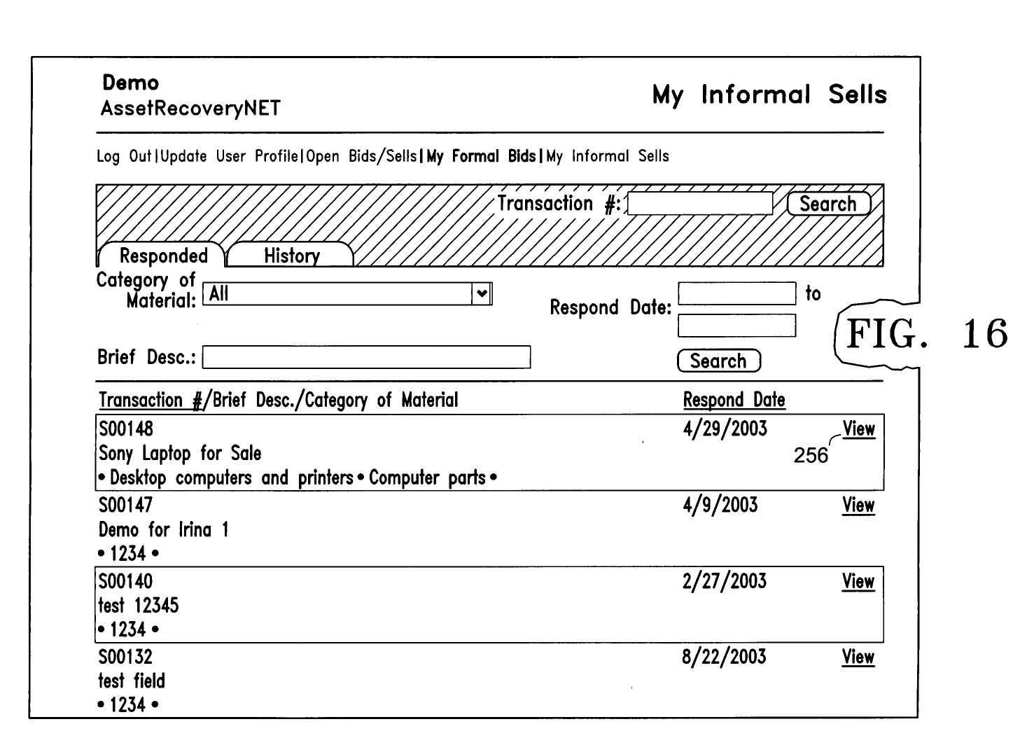

Using the Formal Bid Selection screen depicted in FIG. 15, the Buyer can monitor and View (link 254) the previously submitted Responses, for possible Modification 134 or Withdrawal 136 (see FIG. 5). In a similar manner, the Informal Sell Selection screen of FIG. 16 may be used to monitor and possibly Modify or Withdraw the Buyer's outstanding Responses to Posted Fast Sells via View link 256.

Other implementations and enhancements to the disclosed exemplary apparatus and processes will doubtless be apparent to those skilled in the art, both today and in the future. For example, the invention may be implemented with other computer and network architectures and user interfaces. As another example, many of the data fields may be populated with default preferences previously provided by the user, or determined by heuristic algorithms from archived historical data.

1. An asset recovery system for an organization having a plurality of operational units in which each operational unit has responsibility for identifying material and assets that are no longer required by that unit; said system comprising:
a shared computer network;
first means accessible to an originating operational unit for creating an asset disposal request in a computer readable format;
second means for electronically forwarding the approved request form over the shared computer network to a surplus property disposal professional;
third means accessible to the surplus property disposal professional for converting the approved request form into an electronic posting that is accessible over the shared computer network to interested potential buyers;
fourth means accessible to an interested buyer for converting the electronic posting into a responsive electronic offer; and
fifth means for electronically forwarding the responsive electronic offer over the shared computer network to the surplus property disposal professional; and
sixth means for providing the surplus property disposal professional with discretion whether to designate the electronic posting as a redeployment posting that is accessible only to operational units within the organization.

2. The asset recovery system of claim 1 wherein said redeployment posting specifies a fixed price.

3. The asset recovery system of claim 2 wherein said fixed price is calculated from a predetermined cost.

4. The asset recovery system of claim 2 wherein said fixed price is determined by the surplus property disposal professional.

5. The asset recovery system of claim 1 wherein if no responsive offer is received to a redeployment posting, the redeployment posting is converted to an external posting accessible to registered buyers outside the organization.

6. The asset recovery system of claim 1 further comprising an automated “last and final” bidding process in which a predetermined number of high bidders faces a second round of competitive bidding after the results of an initial round of bidding have been posted.

7. The asset recovery system of claim 6 wherein the surplus property disposal professional has discretion whether to launch said automated “last and final” bidding process.

8. An asset recovery system for material and assets that are no longer required; said system comprising:
first means for creating an asset disposal request in a computer readable format;
second means for electronically forwarding the request to a surplus property disposal professional;
third means accessible to the surplus property disposal professional for converting the approved request form into an electronic posting that is accessible to interested potential buyers;
fourth means accessible to an interested buyer for converting the electronic posting into a responsive electronic offer including a specified price;
fifth means for electronically forwarding the responsive electronic offer to the surplus property disposal professional; and
sixth means for providing the surplus property disposal professional with discretion whether to designate the electronic posting as an open bid posting or as a closed bid posting.

9. The asset recovery system of claim 8 wherein said open bid posting is a fast sale posting in which both the surplus property disposal professional and any other potential buyers have access to said specified price when said responsive offer is submitted by said interested buyer

10. The asset recovery system of claim 9 wherein said open bid posting is a fast sale posting in which both the surplus property disposal professional and any other potential buyers have access to said specified price when said responsive offer is submitted by said interested buyer, and the surplus property disposal professional has discretion to accept any responsive offer from any interested buyer at any time.

11. The asset recovery system of claim 8 wherein said closed bid posting is a formal bid posting in which neither the surplus property disposal professional nor any other potential buyers have access to said specified price until a predetermined closing time.

12. The asset recovery system of claim 8 wherein the interested buyer may withdraw or amend said posting at any time prior to said closing.

13. The asset recovery system of claim 8 wherein the surplus property disposal professional has discretion to withdraw or amend the posting at any time.

14. The asset recovery system of claim 8 further comprising an automated “last and final” bidding process in which a predetermined number of high bidders faces a second round of competitive bidding after the results of an initial round of bidding have been posted.

15. The asset recovery system of claim 14 wherein the surplus property disposal professional has discretion whether to launch said automated “last and final” bidding process.

16. An asset recovery system for an organization having a plurality of operational units in which each operational unit has responsibility for identifying material and assets that are no longer required by that unit; said system comprising:
a shared computer network;
first means accessible to an originating operational unit for creating an asset disposal request in a computer readable format;
second means for electronically forwarding the approved request form over the shared computer network to a surplus property disposal professional;
third means accessible to the surplus property disposal professional for converting the approved request form into an electronic posting that is accessible over the shared computer network to interested potential buyers;
fourth means accessible to an interested buyer for converting the electronic posting into a responsive electronic offer; and
fifth means for electronically forwarding the responsive electronic offer over the shared computer network to the surplus property disposal professional;
wherein
the surplus property disposal professional has discretion whether to designate the electronic posting as a redeployment posting that is accessible only to operational units within the organization and if no responsive offer is received to a redeployment posting to convert the redeployment posting to an external posting accessible to registered buyers outside the organization;
the surplus property disposal professional has discretion whether to designate the electronic posting as an open bid posting or as a closed bid posting;
said open bid posting is a fast sale posting in which both the surplus property disposal professional and any other potential buyers have access to said specified price when said responsive offer is submitted by said interested buyer and the surplus property disposal professional has discretion to accept any responsive offer from any interested buyer at any time;
said closed bid posting is a formal bid posting in which neither the surplus property disposal professional nor any other potential buyers have access to said specified price until a predetermined closing time and said interested buyer may withdraw or amend said formal bid posting at any time prior to said closing;
the surplus property disposal professional has discretion whether to launch an automated “last and final” bidding process in which a predetermined number of high bidders faces a second round of competitive bidding after the results of an initial round of bidding have been posted.

17. A computer assisted method for disposing of material and assets that are no longer required by an operational unit of a larger organization, said method comprising:
creating an asset disposal request in a computer readable format;
electronically forwarding the approved request form over a shared computer network to a surplus property disposal professional;
converting the approved and forwarded request form into an electronic posting from the surplus property disposal professional;
making the electronic posting accessible over the shared computer network to interested potential buyers;
converting the electronic posting into a responsive electronic offer from an identified buyer; and
electronically forwarding the responsive electronic offer over the shared computer network to the surplus property disposal professional.

18. The computer assisted method of claim 17 further comprising:
providing the surplus property disposal professional with discretion whether to designate the electronic posting as a redeployment posting that is accessible only to operational units within the organization.

19. The computer assisted method of claim 18 further comprising:
if no responsive offer is received to a redeployment posting then converting the redeployment posting to an external posting, and making said external posting accessible to registered buyers outside the organization.

20. The computer assisted method of claim 17 further comprising:
providing the surplus property disposal professional with discretion whether to invoke an automated “last and final” bidding process.

21. The computer assisted method of claim 17 further comprising:
providing the surplus property disposal professional with discretion whether to designate the electronic posting as an open bid posting or as a closed bid posting.
